(19) United States
(12) Patent Application Publication
(10) Pub. No.: US 2023/0398769 A1
(43) Pub. Date: Dec. 14, 2023

(54) PARABOLIC AIRCRAFT IMPACT ABSORBING MATERIAL

(71) Applicant: MU-G Technologies, LLC, Titusville, FL (US)

(72) Inventor: Robert Scott Ward, Titusville, FL (US)

(73) Assignee: MU-G Technologies, LLC, Titusville, FL (US)

(21) Appl. No.: 18/332,956

(22) Filed: Jun. 12, 2023

Related U.S. Application Data
(60) Provisional application No. 63/366,285, filed on Jun. 13, 2022.

(51) Int. Cl. B32B 27/06; B32B 5/02; B32B 27/30; B32B 7/12; B32B 5/32; B32B 5/18; B32B 7/022; B32B 27/12

(52) U.S. Cl. CPC B32B 27/065; B32B 5/024; B32B 27/304; B32B 7/12; B32B 5/32; B32B 5/18; B32B 7/022; B32B 27/12; B32B 2605/003; B32B 2255/26; B32B 2307/7376; B32B 2266/08; B32B 2307/718; B32B 2255/02; B32B 2250/04; B32B 2262/101; B32B 2307/72; B32B 2307/56; B32B 2605/18

(57) ABSTRACT

A system for providing impact absorption on an interior surface of an aircraft performing parabolic flight maneuvers including: (1) a liner layer having a first side and an opposing second side; (2) a first compression deflection padding layer having a first side, adhered to the second side of the liner layer, and an opposing second side; (3) a second compression deflection padding layer having a first side, adhered to the second side of the first compression deflection padding layer, and an opposing second side; and (4) a flooring layer having a first side, adhered to the second side of the second compression deflection padding layer, and an opposing second side.

### RELATED APPLICATIONS

This application claims priority under 35 U.S.C. § 119(e) of U.S. Provisional Patent Application Ser. No. 63/366,285 (Attorney Docket No. 4996.00002) filed on Jun. 13, 2022 and titled PARABOLIC AIRCRAFT IMPACT ABSORBING MATERIAL. The content of this application is incorporated herein by reference.

### FIELD OF THE INVENTION

The present invention relates to systems and methods for padding the interior surface of an aircraft equipped for parabolic flight. More specifically, the present invention is directed to a durable impact absorbing material that protects a passenger from injury an aircraft pulls-out of the parabolic maneuver.

### BACKGROUND OF THE INVENTION

In a parabolic aircraft there are two distinct areas of the cabin, the seating area and the floating area. The seating area is similar to the cabin of a commercial airliner. However, in the floating area, the seats are removed and the floor is covered with a protective padding.

The floor of the parabolic aircraft is conventional in all ways except that it is covered with foam padding to facilitate passenger comfort and safety during parabolic flight. Known designs utilize a composite pad consisting of a layer of Naugahyde®, which is bonded to 1.5 inch Ensolite® ALC foam. This composite pad is secured to the floor of the aircraft or a cargo pallet with hook and loop fasteners. Testing has proven this method inadequate to sufficiently absorb and protect the passengers from the resultant high-g forces experienced during the pull-out of the parabolic maneuver. Therefore, a need exists for an impact absorbing material sufficient to protect passengers during the pull-out of the parabolic maneuver.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system for providing impact absorption on an interior surface of an aircraft performing parabolic flight maneuvers. The system may include a liner layer, a first compression deflection padding layer, a second compression deflection padding layer, and a flooring layer.

The liner layer may have a first side and an opposing second side.

The liner layer may include a woven cloth and a phenolic resin coating at least a portion of the woven fiberglass cloth.

The liner layer may further include a polyvinyl fluoride film secured to the woven cloth on a first side of the liner layer.

The liner layer may have a thickness greater than or equal to 0.013 millimeters and less than or equal to 0.060 millimeters.

The liner layer may have an impact strength greater than or equal to eleven foot-pounds.

The first compression deflection padding layer may have a first side, adhered to the second side of the liner layer, and an opposing second side.

The first compression deflection padding layer may include a closed cell foam.

The first compression deflection padding layer may have a thickness greater than 0.9 inches and less than 1.1 inches.

The first compression deflection padding layer may have a 25% compression deflection force equal to or greater than 9.0 psi and less than or equal to 13.0 psi.

The first compression deflection padding layer may have a density equal to or greater than 7.0 pounds per cubic foot and less than or equal to 9.5 pounds per cubic foot.

The second compression deflection padding layer may have a first side, adhered to the second side of the first compression deflection padding layer, and an opposing second side.

The second compression deflection padding layer may include a closed cell foam.

The second compression deflection padding layer may have a thickness greater than 0.4 inches and less than 0.6 inches.

The second compression deflection padding layer may have a 25% compression deflection force equal to or greater than 2.0 psi and less than or equal to 5.0 psi.

The second compression deflection padding layer may have a density equal to or greater than 3.0 pounds per cubic foot and less than or equal to 5.5 pounds per cubic foot.

The first compression deflection padding layer may have a 25% compression deflection force greater than a 25% compression deflection force of the second compression deflection padding layer.

The first compression deflection padding layer may have a density greater than a density of the second compression deflection padding layer.

The flooring layer may have a first side, adhered to the second side of the second compression deflection padding layer, and an opposing second side.

The flooring layer may include polyvinyl chloride.

The flooring layer may have a thickness greater than 2.0 millimeters and less than 3.0 millimeters.

The flooring layer may have a weight of greater than or equal to 3100 grams per square meter and less than or equal to 3500 grams per square meter.

The system may further include a fastener secured to the first side of the liner layer and adapted to removably secure to the interior surface.

### BRIEF DESCRIPTION OF THE DRAWINGS

Some embodiments of the present invention are illustrated as an example and are not limited by the figures of the accompanying drawings, in which like references may indicate similar elements.

FIG. 1 is a stack up of the durable impact absorbing material according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various FIGURES and accompanying text, provides a durable impact absorbing material 100. The durable impact absorbing material 100 may include one or more layers of foam, adhesive and laminate that can be attached to the floor of an aircraft equipped for parabolic flight via an easily removable method such as hook and loop fasteners. One with skill in the art will appreciate that it may be necessary for the materials used to provide the necessary safety protection and the ability to pass all materials test as set out by the FAA 14 CFR Part 25.853.

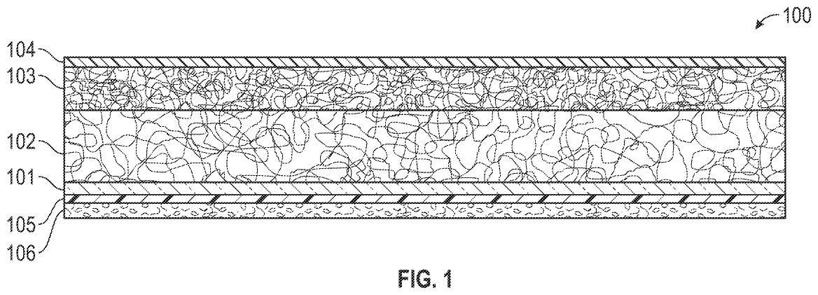

The durable impact absorbing material 100 may provide a better floor padding designed to absorb the high-g forces experienced during the pullout of the parabolic maneuver. This durable impact absorbing material 100 may be a composite of multiple materials. In one embodiment, as an example, and not as a limitation, the durable impact absorbing material 100 may include four distinct materials. As depicted in FIG. 1, a liner layer 101 may be positioned adjacent to and have a first side bonded to higher compression deflection padding layer 102 on a first side of the higher compression deflection padding layer 102. A second side of the higher compression deflection padding layer 102 may be bonded to a first side of a lower compression deflection padding layer 103. The second side of the lower compression deflection padding layer 103 may be bonded to a flooring layer 104.

The liner layer 101 may be provided by Gillfab® 1367A or the like. The liner layer 101 may provide a high strength material constructed of woven E or S-glass cloth with a phenolic resin system. The phenolic resin may coat at least a portion of the woven glass cloth. In one embodiment, the phenolic resin may coat an entirety of the woven cloth. A 1 ml polyvinyl fluoride film 105 may overlay the resin system on the first side. In one embodiment, the polyvinyl fluoride film may be white to provide surface reflectivity and a uniform appearance. The liner layer 101 may have a high impact strength, be fire resistant, corrosion resistant, have a low moisture absorption, and generate low smoke and toxicity. The liner layer 101 may have a service temperature of −40 F to 220 F. In one embodiment, the thickness of the liner layer 101 may be between 0.013 mm and 0.060 mm. More specifically, the thickness of the liner layer 101 may be 0.013, 0.020, 0.025, 0.030, 0.040, 0.045, or 0.060 mm. The impact strength of the liner layer 101 may be between 11 ft-lbs and 32 ft-lbs. More specifically, the impact strength of the liner layer 101 may be 11, 15, 18, 19, 25, 25, or 32 ft-lbs. The warp bolted joint strength of the liner layer 101 may be between 225 and 385 N. More specifically, the warp bolted joint strength of the liner layer 101 may be 225, 254, 312, or 385 N. The fill bolted joint strength of the liner layer 101 may be between 233 and 390 N. More specifically, the fill bolted joint strength may be 233, 261, 314, or 390 N. The warp double point edge bearing may be 315 N and the fill double point edge bearing may be 310 N. The liner layer may meet FAR 25,853 & 855 Appendix F Part I & III requirements for flammability.

The higher compression deflection padding layer 102 may include Skandia SKIV3 padding. In one embodiment, the higher compression deflection padding layer 102 may be a closed cell foam. The higher compression deflection padding layer 102 may have a thickness greater than 0.9 inches and less than 1.1 inches. In one embodiment, the higher compression deflection padding layer 102 may have a thickness of one inch. The 25% compression deflection force of the higher compression deflection padding layer 102 may range from 9.0 to 13.0 psi and meet ASTM D1056 specifications. The 50% compression set of the higher compression deflection padding layer 102 may be 40%. The higher compression deflection padding layer 102 may have a density ranging from 7.0 to 9.5 pcf, a tensile of 100 psi, and an elongation of 100%. The higher compression deflection padding layer 102 may pass 14 CFR25.853(a) 12-second vertical and MVSS302 requirements.

The lower compression deflection padding layer 103 may include Skandia SKIV1 padding. In one embodiment, the lower compression deflection padding layer 103 may have a closed cell foam. In one embodiment, the lower compression deflection padding layer 103 may have a thickness equal to or greater than 0.4 inches and less than or equal to 0.6 inches. In one embodiment, the lower compression deflection padding layer 103 may have a thickness of half an inch. The 25% compression deflection force of the lower compression deflection padding layer 103 may range from 2.0 to 5.0 psi and meet ASTM D1056 specifications. The 50% compression set of the lower compression deflection padding layer 103 may be 40%. The lower compression deflection padding layer 103 may have a density ranging from 3.0 to 5.5 pcf, a tensile of 50 psi, and an elongation of 100%. The lower compression deflection padding layer 103 may pass 14 CFR25.853(a) 12-second vertical and MVSS302 requirements.

This durable impact absorbing material 100 may allow for the maximum protection of the passengers during the pull-out of the high-g maneuver. The interaction with the combination of the higher compression deflection padding layer 102 and the lower compression deflection padding layer 103 allows for the energy of the passenger landing on the floor to be adequately absorbed to minimize the possibility of a resultant injury.

The flooring layer 104 may include Aerofloor AF66. The flooring layer 104 may be a flame retardant polyvinyl chloride flooring. The flooring layer 104 may have a thickness greater than or equal to 2.0 millimeters and less than or equal to 3.0 millimeters. In one embodiment, the thickness of the flooring layer 104 may be 2.5 mm. The flooring layer may have a weight greater than or equal to 3100 grams per square meter and less than or equal to 3500 grams per square meter. In on embodiment, the flooring layer may have a weight of 3300 grams per square meter.

During testing, the durable impact absorbing material 100 as described herein may generate a HIC (Head Injury Criterion) value of 506, which is one-third the HIC value of 1558 for a padding that does not include both a higher compression deflection padding layer 102 and a lower compression deflection padding layer 103. This reduction in HIC reduces the probability of a serious injury from a 4 foot fall from approximately 90% to 13%.

The liner layer 101 bonded to the bottom of the durable impact absorbing material 100 provides for extra rigidity. The liner layer 101 is an adequate material that can be used to attach the composite padding to the floor of the aircraft through either fasteners, including, but not limited to hooks and loops, or the like. A fastener 106 may be secured to a second side of the liner layer 101. In one embodiment, the fastener 106 may be one portion of a hook and loop fastener. In such an embodiment, a corresponding loop or hook fastener may be affixed to an interior surface of the aircraft to facilitate securing the durable impact absorbing material 100 to the floor of the aircraft.

The flooring layer 104 bonded to the second side of the lower compression deflection padding layer 103 may provide a covering that is suitable for passengers to walk on and is also durable enough to protect the lower compression deflection padding layer 103 and higher compression deflection padding layer 102 from damage.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A system for providing impact absorption on an interior surface of an aircraft performing parabolic flight maneuvers comprising:
a liner layer having a first side and an opposing second side;
a first compression deflection padding layer having a first side, adhered to the second side of the liner layer, and an opposing second side;
a second compression deflection padding layer having a first side, adhered to the second side of the first compression deflection padding layer, and an opposing second side; and
a flooring layer having a first side, adhered to the second side of the second compression deflection padding layer, and an opposing second side.

2. The system of claim 1 wherein the liner layer further comprises:
a woven cloth; and
a phenolic resin coating at least a portion of the woven fiberglass cloth.

3. The system of claim 2 wherein the liner layer further comprises:
a polyvinyl fluoride film secured to the woven cloth on a first side of the liner layer.

4. The system of claim 1 wherein the liner layer has a thickness greater than or equal to 0.013 millimeters and less than or equal to 0.060 millimeters.

5. The system of claim 1 wherein the liner layer has an impact strength greater than or equal to eleven foot-pounds.

6. The system of claim 1 wherein the first compression deflection padding layer comprises a closed cell foam.

7. The system of claim 1 wherein the first compression deflection padding layer has a thickness greater than 0.9 inches and less than 1.1 inches.

8. The system of claim 1 wherein the first compression deflection padding layer has a 25% compression deflection force equal to or greater than 9.0 psi and less than or equal to 13.0 psi.

9. The system of claim 1 wherein the first compression deflection padding layer has a density equal to or greater than 7.0 pounds per cubic foot and less than or equal to 9.5 pounds per cubic foot.

10. The system of claim 1 wherein the second compression deflection padding layer comprises a closed cell foam.

11. The system of claim 1 wherein the second compression deflection padding layer has a thickness greater than 0.4 inches and less than 0.6 inches.

12. The system of claim 1 wherein the second compression deflection padding layer has a 25% compression deflection force equal to or greater than 2.0 psi and less than or equal to 5.0 psi.

13. The system of claim 1 wherein the second compression deflection padding layer has a density equal to or greater than 3.0 pounds per cubic foot and less than or equal to 5.5 pounds per cubic foot.

14. The system of claim 1 wherein the first compression deflection padding layer has a 25% compression deflection force greater than a 25% compression deflection force of the second compression deflection padding layer.

15. The system of claim 1 wherein the first compression deflection padding layer has a density greater than a density of the second compression deflection padding layer.

16. The system of claim 1 wherein the flooring layer comprises polyvinyl chloride.

17. The system of claim 1 wherein the flooring layer has a thickness greater than 2.0 millimeters and less than 3.0 millimeters.

18. The system of claim 1 wherein the flooring layer has a weight of greater than or equal to 3100 grams per square meter and less than or equal to 3500 grams per square meter.

19. The system of claim 1 further comprising a fastener secured to the first side of the liner layer and adapted to removably secure to the interior surface.

20. A system for providing impact absorption on an interior surface of an aircraft performing parabolic flight maneuvers comprising:
a liner layer having a first side and an opposing second side, wherein the liner layer further comprises:
a woven cloth,
a phenolic resin coating at least a portion of the woven fiberglass cloth, and
a polyvinyl fluoride film secured to the woven cloth on a first side of the liner layer;
a first compression deflection padding layer having a first side, adhered to the second side of the liner layer, and an opposing second side, wherein the first compression deflection padding layer further comprises:
a first closed cell foam;
a second compression deflection padding layer having a first side, adhered to the second side of the first compression deflection padding layer, and an opposing second side, wherein the second compression deflection padding layer comprises:
a closed cell foam;
a flooring layer having a first side, adhered to the second side of the second compression deflection padding layer, and an opposing second side, wherein the flooring layer comprises:
polyvinyl chloride; and
a fastener secured to the first side of the liner layer and adapted to removably secure to the interior surface; and
wherein the liner layer has a thickness greater than or equal to 0.013 millimeters and less than or equal to 0.060 millimeters;
wherein the liner layer has an impact strength greater than or equal to eleven foot-pounds;
wherein the first compression deflection padding layer has a thickness greater than 0.9 inches and less than 1.1 inches;
wherein the first compression deflection padding layer has a 25% compression deflection force equal to or greater than 9.0 psi and less than or equal to 13.0 psi;
wherein the first compression deflection padding layer has a density equal to or greater than 7.0 pounds per cubic foot and less than or equal to 9.5 pounds per cubic foot;
wherein the second compression deflection padding layer has a thickness greater than 0.4 inches and less than 0.6 inches;
wherein the second compression deflection padding layer has a 25% compression deflection force equal to or greater than 2.0 psi and less than or equal to 5.0 psi;
wherein the second compression deflection padding layer has a density equal to or greater than 3.0 pounds per cubic foot and less than or equal to 5.5 pounds per cubic foot;
wherein the flooring layer has a thickness greater than 2.0 millimeters and less than 3.0 millimeters; and
wherein the flooring layer has a weight of greater than or equal to 3100 grams per square meter and less than or equal to 3500 grams per square meter.
